(19) United States
(12) Patent Application Publication
(10) Pub. No.: US 2009/0191751 A1
(43) Pub. Date: Jul. 30, 2009

(54) COAXIAL CABLE ALIGNMENT ENHANCER FOR USE WITHIN COAXIAL CABLE ASSEMBLIES SO AS TO ENSURE THE PROPER COAXIAL DISPOSITION OF THE COAXIAL CABLE CONTACT MEMBERS OF COAXIAL CABLE ELECTRICAL CONNECTORS

(75) Inventors: Gregory Barsigian, Vestal, NY (US); Kevin D. Looney, Lexington Park, MD (US); Michael J. Malia, Owego, NY (US)

Correspondence Address: MICHAEL BEST & FRIEDRICH LLP, 100 E WISCONSIN AVENUE, Suite 3300, MILWAUKEE, WI, 53202, US

(73) Assignee: LOCKHEED MARTIN CORPORATION, Bethesda, MD (US)

(21) Appl. No.: 12/021,016

(22) Filed: Jan. 28, 2008

(51) Int. Cl. H01R 9/05

(52) U.S. Cl. 439/579

(57) ABSTRACT

A coaxial cable assembly comprises a coaxial cable alignment enhancer which has a plurality of axially oriented recesses defined within its outer peripheral surface portion for accommodating a plurality of electrical cables. A securing member is disposed around the alignment enhancer so as to in fact maintain the plurality of cables disposed within the recesses. In this manner, the plurality of cables are in fact disposed in a true coaxial manner with respect to each other whereby electrical contact members of the cables are, in turn, disposed in a true coaxial manner with respect to each other so as to be capable of being engaged with corresponding electrical contact members of another electrical connector without experiencing any deformation and damage.

### FIELD OF THE INVENTION

The present invention relates generally to coaxial cable assemblies for use in conjunction with coaxial cable electrical connectors, and more particularly to a new and improved coaxial cable assembly which utilizes a new and improved coaxial cable alignment enhancer around and through which a multiplicity of coaxial cables are disposed and maintained in engaged contact with the coaxial cable alignment enhancer so as to ensure the fact that coaxial cable contact members, disposed upon the free distal end portions of the multiplicity of coaxial cables, are properly aligned in a coaxial manner with respect to each other so as to, in turn, ensure the fact that the multiplicity of coaxial cable contact members can be easily and properly aligned with, and electrically connected to, mating coaxial cable contact members of a mating coaxial cable electrical connector. In this manner, not only is the physical and electrical mating of the complementary coaxial cable electrical connectors readily facilitated, but in addition, damage to the coaxial cable contact members is effectively prevented.

### BACKGROUND OF THE INVENTION

When male and female coaxial cable electrical connectors, each comprising a multiplicity of coaxial cables, are desired to be physically and electrically connected together, it is not only desirable, but operationally imperative, that the multiplicity of coaxial cable contact members, disposed upon the free distal end portions of the multiplicity of coaxial cables disposed within each one of the male and female coaxial cable electrical connectors, are properly aligned in a coaxial manner with respect to each other so as to, in turn, ensure the fact that the multiplicity of coaxial cable contact members can be easily and properly aligned with, and electrically connected to, mating coaxial cable contact members of a mating coaxial cable electrical connector. In this manner, not only is the physical and electrical mating of the complementary male and female coaxial cable electrical connectors readily facilitated, but in addition, damage to the coaxial cable contact members is effectively prevented. More particularly, it can be readily appreciated that if some or all of the coaxial cable contact members are not disposed in the aforenoted coaxially aligned mode, array, or arrangement, then when the male and female coaxial cable electrical connectors are to be physically and electrically connected together, then in lieu of the various coaxial cable contact members properly mating with each other in a coaxially aligned manner, they would in fact engage each other in a substantially coaxially non-aligned or misaligned manner whereby the various coaxial cable contact members will either be bent out of alignment, deformation, or otherwise damaged. The end result of course will be that the required electrical connections, defined between the various coaxial cables, will not in fact be able to be achieved. The electrical connector assemblies would then have to be disassembled, the damaged coaxial cable contact members would have to be repaired or replaced, and operator personnel would again have to attempt to physically and electrically connect the electrical connector assemblies together without again damaging, bending, or otherwise deforming the coaxial cable contact members.

The reason that the aforenoted phenomena of misalignment or non-alignment of the various coaxial cable contact members conventionally occurs can be readily appreciated and understood when reference is made to FIGS. 1-4. As illustrated within FIGS. 1-4, a conventional PRIOR ART coaxial cable assembly is disclosed and is generally indicated by the reference character 100. More particularly, it is seen that the conventional PRIOR ART coaxial cable assembly 100 comprises a plurality of substantially coaxially aligned cables 102 extending along and around a longitudinal axis LA, and that the free distal end portions of each one of the plurality of substantially coaxially aligned cables 102 is provided with an electrical contact member 104. The free distal end portions of the plurality of substantially coaxially aligned cables 102, having the electrical contact members 104 respectively disposed thereon, are adapted to be inserted into, and disposed within, an electrical connector 106. The electrical connector 106 has a diametrically extending rear end or upstream wall or disc member 108 which is oriented substantially perpendicular to the longitudinal axis LA and which has an axial thickness that extends to an axially central position internally within the electrical connector 106. The internal wall member 108 is provided with a plurality of apertures 110 through which the forward end portions of the contact members 104 of the substantially coaxially aligned cables 102 extend or project. In addition, in order to effectively bundle the plurality of substantially coaxially aligned cables 102 together, a securing member 112, which may comprise, for example, a tie, a lace, a cord, a cable, a band, tape, or the like, is secured around the plurality of cables 102, and a backshell member 114 is adapted to be mated with the electrical connector 106 in order to complete the coaxial cable assembly 100. More specifically, for example, the external peripheral surface portion of the back or rear end region of the electrical connector 106 is provided with a first set of suitable circumferentially extending threads 116, and in a similar manner, the internal peripheral surface portion of the backshell member 114 is provided with a second set of suitable circumferentially extending threads 118 whereby the backshell member 114 and the electrical connector 106 can be threadedly connected together.

With reference continuing to be made to FIGS. 1-4, it can be appreciated and understood that when the securing member 112 is in fact disposed around the plurality of substantially coaxially aligned cables 102 in order to effectively bundle the plurality of substantially coaxially aligned cables 102 together, the free distal end portions of the plurality of substantially coaxially aligned cables 102, upon which the plurality of electrical contact members 104 are respectively disposed, splay radially outwardly whereby the free distal end portions of the plurality of substantially coaxially aligned cables 102 are no longer truly disposed in a coaxial manner with respect to each other. To the contrary, one or more of the free distal end portions of the plurality of substantially coaxially aligned cables 102 are now disposed at some acute angle A with respect to the longitudinal axis LA of the coaxial cable assembly 100 and with respect to, for example, the axially central one of the plurality of substantially coaxially aligned cables 102.

Accordingly, it can therefore be readily appreciated still further that when the electrical connector 106, which in this instances effectively comprises a male electrical connector, is adapted to be physically and electrically connected to a complementary female electrical connector, it will be extremely difficult to properly align the male electrical contact members 104 of the male electrical connector 106 of the coaxial cable assembly 100 with the female electrical contact members of a female electrical connector of a complementary coaxial cable assembly. More particularly, as the male electrical connector 106 is adapted to be physically and electrically connected to the complementary female electrical connector, any misaligned male electrical contact members 104 of the male electrical connector 106 will not readily engage and mate with the corresponding or complementary female electrical contact members of the female electrical connector and will accordingly undergo bending, deformation, or other damage. Obviously, in addition, the desired electrical connections will not in fact be achieved.

A need therefore exists in the art for a new and improved a new and improved coaxial cable assembly wherein the multiplicity of the coaxially aligned cables, disposed within a first electrical connector which is adapted to be physically and electrically connected to a second electrical connector, are in fact maintained at their true coaxially aligned positions with respect to each other such that when the first electrical connector, having the multiplicity of coaxially aligned cables disposed therein, is to be physically and electrically connected to the second corresponding or complementary electrical connector, the electrical contact members of the first electrical connector will be able to be readily, easily, and accurately mated with and connected to the electrical contact members of the second electrical connector.

### SUMMARY OF THE INVENTION

The foregoing and other objectives are achieved in accordance with the teachings and principles of the present invention through the provision of a new and improved coaxial cable assembly which comprises a coaxial cable alignment enhancer which is adapted to be disposed within the new and improved coaxial cable assembly at an axial position immediately upstream or behind the electrical connector as viewed in the axial direction of movement of the electrical connector when the electrical connector is to be physically and electrically connected to a corresponding or complementary electrical connector. The alignment enhancer comprises an axially elongated rod or tubular member having a plurality of axially oriented recesses, slots, or channels, disposed within an annular array, defined within the outer peripheral surface portion of the enhancer. In addition, an axially oriented central throughbore may also be defined within the enhancer so as to extend along the longitudinal axis of the enhancer.

The multiplicity of coaxially oriented cables may be respectively disposed within the plurality of axially oriented recesses, slots, or channels, and a securing member, which may comprise, for example, a tie, a band, a cable, a lace, a cord, tape, or the like, is disposed around the alignment enhancer so as to in fact maintain the multiplicity of coaxially oriented cables disposed within their respective axially oriented recesses, slots, or channels. In this manner, it is ensured that the multiplicity of coaxially oriented cables are in fact disposed in a true coaxial manner with respect to each other, and accordingly, the electrical contact members, respectively disposed upon the free distal end portions of the multiplicity of coaxially oriented and coaxially aligned cables, are themselves disposed in a true coaxial manner with respect to each other so as to be capable of being readily engaged and mated with corresponding electrical contact members of another electrical connector with which the electrical connector of the new and improved coaxial cable assembly is to be physically and electrically connected.

### BRIEF DESCRIPTION OF THE DRAWINGS

Various other objects, features, and attendant advantages of the present invention will be more fully appreciated from the following detailed description when considered in connection with the accompanying drawings in which like reference characters designate like or corresponding parts throughout the several views, and wherein:

FIG. 1 is an exploded perspective view of a conventional PRIOR ART coaxial cable assembly wherein a multiplicity of cables are bundled together;

FIG. 2 is a perspective view of the conventional PRIOR ART coaxial cable assembly as disclosed within FIG. 1 wherein the various components of the coaxial cable assembly have been assembled together;

FIG. 3 is an end elevational view of the assembled conventional PRIOR ART coaxial cable assembly as disclosed within FIG. 2;

FIG. 4 is a cross-sectional view of the assembled conventional PRIOR ART coaxial cable assembly as disclosed within the FIGS. 2 and 3 and as taken along the lines 4-4 of FIG. 3, only several of the coaxial cables of the coaxial cable assembly being illustrated for clarity purposes;

FIG. 5 is a perspective view of a new and improved coaxial cable alignment enhancer, as constructed in accordance with the principles and teachings of the present invention, and which is to be utilized in conjunction with the new and improved coaxial cable assembly of the present invention;

FIG. 6 is an exploded perspective view, similar to that of FIG. 1, showing, however, a new and improved coaxial cable assembly, as constructed in accordance with the principles and teachings of the present invention, and which has the new and improved coaxial cable alignment enhancer, as illustrated within FIG. 5, incorporated therewithin whereby a multiplicity of cables are able to be bundled together in a truly coaxially aligned array;

FIG. 7 is a perspective view, similar to that of FIG. 2, showing, however, the new and improved coaxial cable assembly of FIG. 6 wherein the various components of the coaxial cable assembly have been assembled together;

FIG. 8 is an end elevational view, similar to that of FIG. 3, showing, however, the assembled coaxial cable assembly as disclosed within FIG. 7; and

FIG. 9 is a cross-sectional view, similar to that of FIG. 4, showing, however, the assembled coaxial cable assembly as disclosed within the FIGS. 7 and 8 and as taken along the lines 9-9 of FIG. 8, only several of the coaxial cables of the coaxial cable assembly being illustrated for clarity purposes, wherein it can be seen that the multiplicity of cables are in fact disposed within a truly coaxially aligned array with respect to each other.

### DETAILED DESCRIPTION OF THE PREFERRED EMBODIMENT

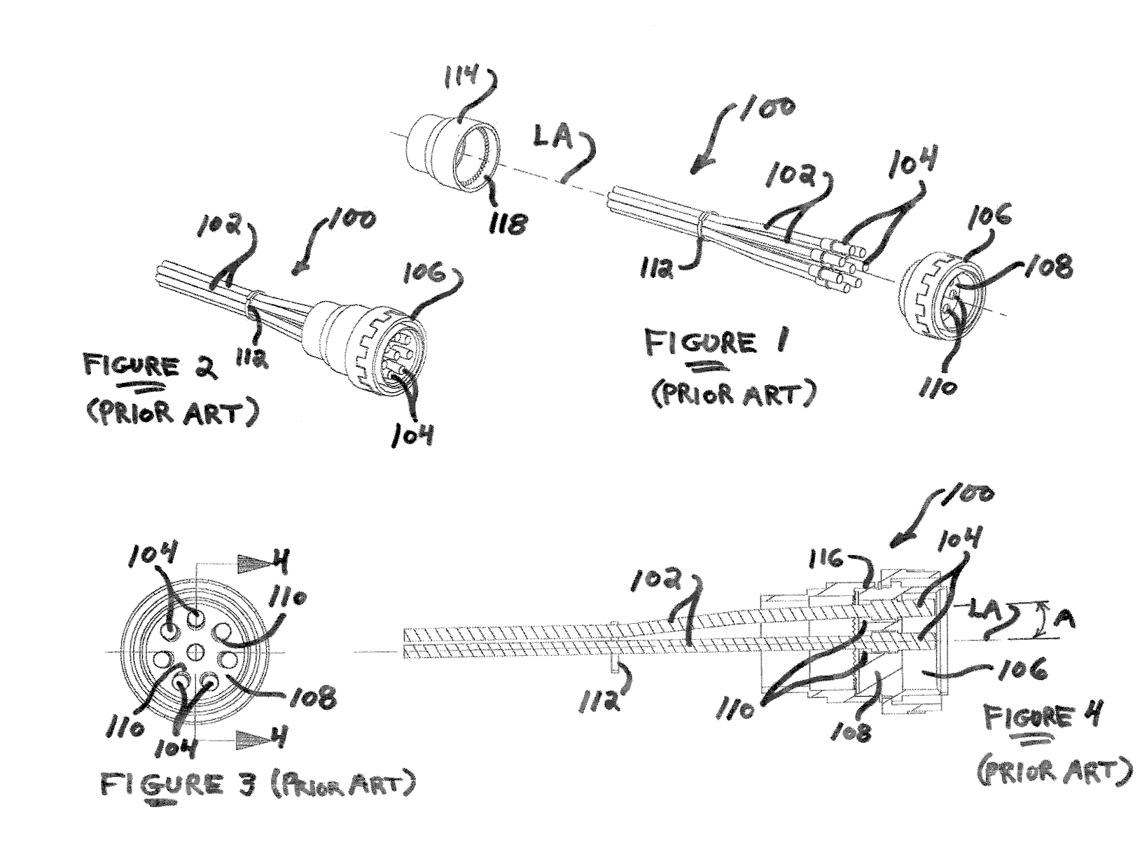

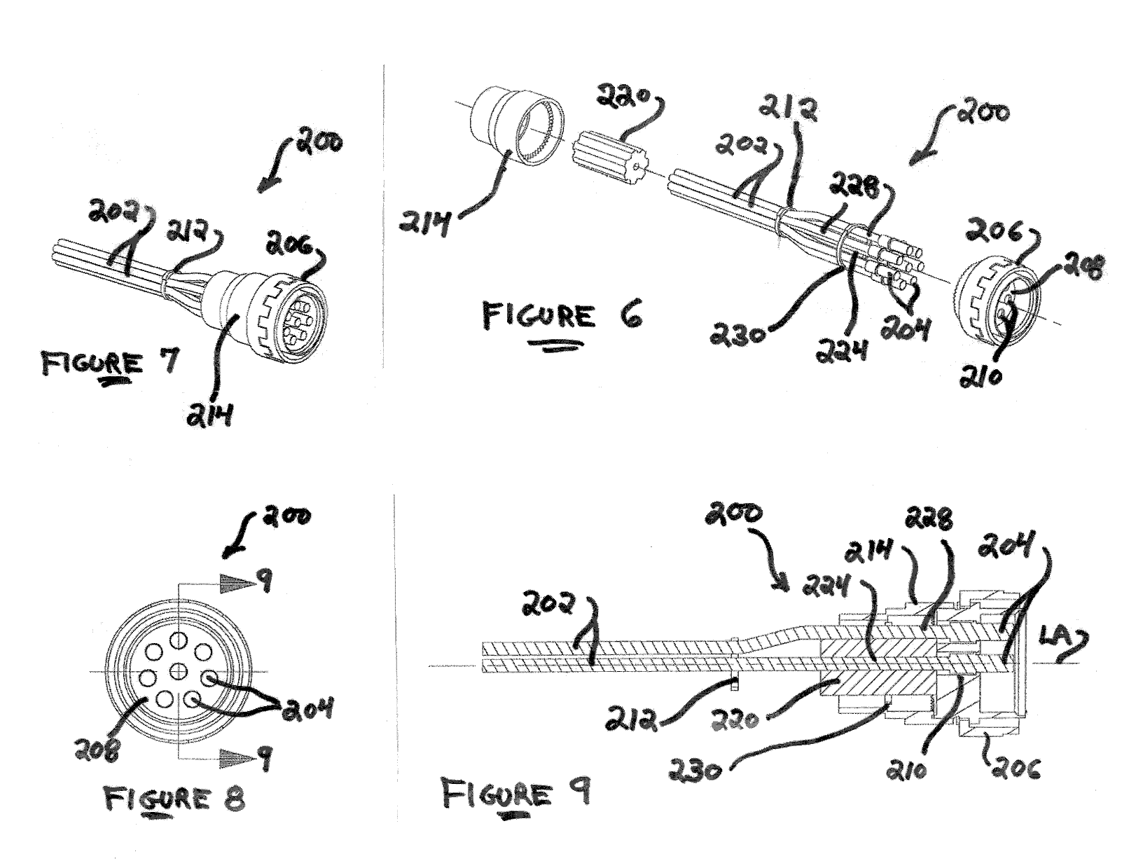

Referring now to the drawings, and more particularly to FIGS. 6-9 thereof, a new and improved coaxial cable assembly, as constructed in accordance with the principles and teachings of the present invention, and which has a new and improved coaxial cable alignment enhancer, as illustrated within FIG. 5, incorporated therewithin such that a multiplicity of cables are able to be bundled together in a truly coaxially aligned array, is disclosed and is generally indicated by the reference character 200. It is to be noted that, in view of some basic structural similarities of the new and improved coaxial cable assembly 200 as disclosed within FIGS. 6-9, as compared to the conventional PRIOR ART coaxial cable assembly 100 as disclosed within FIGS. 1-4, and for brevity purposes, an exhaustive description of the new and improved coaxial cable assembly 200 will be omitted herefrom and that the description of the new and improved coaxial cable assembly 200 will be directed toward the new and improved structural features thereof. In addition, component parts of the new and improved coaxial cable assembly 200, which correspond to component parts of the conventional PRIOR ART coaxial cable assembly 100, will be designated by corresponding reference characters except for the fact that they will be within the 200 series. More particularly, it is seen that the new and improved coaxial cable assembly 200 comprises a plurality of substantially coaxially aligned cables 202 extending along and around a longitudinal axis LA, and that the free distal end portions of each one of the plurality of substantially coaxially aligned cables 202 is provided with an electrical contact member 204.

The free distal end portions of the plurality of substantially coaxially aligned cables 202, having the electrical contact members 204 respectively disposed thereon, are adapted to be inserted into, and disposed within, an electrical connector 206. The electrical connector 206 has a diametrically extending rear end or upstream wall or disc member 208 which is oriented substantially perpendicular to the longitudinal axis LA and which has an axial thickness that extends to an axially central position internally within the electrical connector 206. The internal wall member 208 is provided with a plurality of apertures 210 through which the forward end portions of the contact members 204 of the substantially coaxially aligned cables 202 extend or project. In addition, in order to effectively bundle the plurality of substantially coaxially aligned cables 202 together, a first securing member 212, which may comprise, for example, a cable, a tie, a lace, a cord, a band, tape, or the like, is secured around the plurality of cables 202, and a backshell member 214 is adapted to be mated with the electrical connector 206 in order to substantially complete the coaxial cable assembly 200 except as will be noted further hereinafter. More specifically, for example, the external peripheral surface portion of the back or rear end region of the electrical connector 206 is pro-vided with a first set of suitable circumferentially extending threads 216, and in a similar manner, the internal peripheral surface portion of the backshell member 214 is provided with a second set of suitable circumferentially extending threads 218 whereby the backshell member 214 and the electrical connector 206 can be threadedly connected together.

As has been noted in connection with the conventional coaxial cable assembly 100 illustrated within FIGS. 1-4, when the securing member 212 is in fact disposed around the plurality of substantially coaxially aligned cables 202 in order to effectively bundle the plurality of substantially coaxially aligned cables 202 together, the free distal end portions of the plurality of substantially coaxially aligned cables 202, upon which the plurality of electrical contact members 204 are respectively disposed, will tend to splay radially outwardly whereby the free distal end portions of the plurality of substantially coaxially aligned cables 202 will no longer be truly disposed in a coaxial manner with respect to each other and will tend to be disposed at an acute angle A with respect to the longitudinal axis LA of the coaxial cable assembly 200 and with respect to, for example, the axially central one of the plurality of substantially coaxially aligned cables 202, as was illustrated in connection with the coaxial cable assembly 100 of FIGS. 1-4. Accordingly, as has also been previously noted, if the electrical connector 206, as disclosed to this point, and which in this instances effectively comprises a male electrical connector, is attempted to be physically and electrically connected to a complementary female electrical connector, it would be extremely difficult to properly align the radially outwardly splayed, non-coaxially aligned male electrical contact members 204 of the male electrical connector 206 of the coaxial cable assembly 200 with the female electrical contact members of a female electrical connector of a complementary coaxial cable assembly. However, in accordance with further principles and teachings of the pre-sent invention, this non-coaxially aligned disposition of the plurality of cables 202 and the electrical contact members 204 disposed thereon will effectively be altered, modified, or corrected such that the multiplicity of electrical cables 202 and the electrical contact members 204 disposed thereon will in fact be disposed within a true coaxially aligned array with respect to each other.

More particularly, with reference being made to FIG. 5, a new and improved coaxial cable alignment enhancer 220 is provided for use within the new and improved coaxial cable assembly 200. As can readily be appreciated from FIG. 5, the new and improved coaxial cable alignment enhancer 220 comprises an axially elongated tubular member which is fabricated from a suitable dielectric material and which has a central passageway or throughbore 222 extending therethrough along the longitudinal axis thereof for accommodating a central one 224 of the multiplicity of electrical cables 202 which extends along the longitudinal axis LA of the coaxial cable assembly 200. In addition, it is also seen that the coaxial cable alignment enhancer 220 has a plurality of axially oriented, arcuately configured or radiused, recesses, pockets, channels, or the like, 226 defined within the outer peripheral surface portion of the coaxial cable alignment enhancer 220 for likewise respectively accommodating individual ones 228 of the plurality of electrical cables 202 which are disposed within the radially outwardly annular array of electrical cables 202 which annularly surround the axially central one 224 of the electrical cables 202. The plurality of axially oriented recesses, pockets, channels, or the like, 226 are circumferentially spaced from each other in a uniform manner around the longitudinal axis of the alignment enhancer 220, and while it is seen that the coaxial cable alignment enhancer 220 is provided, as an example, with seven (7) axially oriented recesses, pockets, or channels 226 for respectively accommodating the individual, radially outer electrical cables 228, the specific number of such axially oriented recesses, pockets, or channels 226 may vary depending upon the particular electrical connector application and the required number of electrical cables 202.

Still yet further, it is also to be appreciated that, in addition to the first securing member 212, which may comprise, for example, a cable, a tie, a lace, a cord, a band, tape, or the like, and which has been secured around the plurality of cables 202 in order to effectively preliminarily bundle the plurality of cables 202 together, a second securing member 230 is also utilized in connection with the plurality of cables which are disposed within the radially outer annular or circumferential array of cables 228 and which are adapted to be seated within the aforenoted axially oriented recesses, pockets, channels, or the like, 226 of the coaxial cable alignment enhancer 220. More particularly, the second securing member 230, which is disposed within a radial plane at a substantially axially central position, as considered along the axial extent of coaxial cable alignment enhancer 220 as can best be appreciated from FIG. 9, and which also may comprise, for example, a tie, a lace, a cord, a cable, a band, tape, or the like, serves two primary purposes within the new and improved coaxial cable assembly 200. Firstly, the second securing member 230 maintains the plurality of electrical cables, that effectively form the radially outer annular or circumferential array of cables 228, seated within their respective axially oriented pockets, recesses, or channels 226 of the coaxial cable alignment enhancer 220.

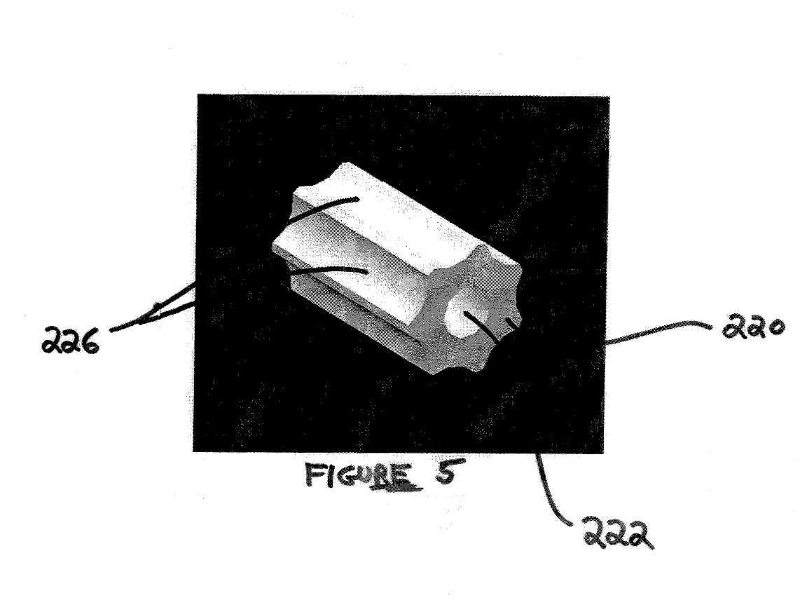

Secondly, as a result of the disposition of the second securing member 230 around the plurality of electrical cables 228, which effectively form the radially outer annular or circumferential array of cables and which are seated within their respective axially oriented pockets, channels, or recesses 226 of the coaxial cable alignment enhancer 220, the plurality of electrical cables 228, which effectively form the radially outer annular or circumferential array of cables and which are seated within their respective axially oriented channels, pockets, or recesses 226 of the coaxial cable alignment enhancer 220, are effectively forced to respectively engage the external surface portions of the axially oriented recesses, pockets, or channels 226 of the coaxial cable alignment enhancer 220 along the entire axial extents of the recesses, pockets, or channels 226. In this manner, as can be readily appreciated from FIG. 9, wherein the coaxial cable alignment enhancer 220 is disposed internally within the backshell member 214 of the coaxial cable assembly 200 so as to be disposed at an axial position immediately upstream of, or behind, the electrical connector 206 as viewed in the axial direction of movement of the electrical connector 206 when the electrical connector 206 is to be physically and electrically connected to a corresponding or complementary electrical connector, and especially when the coaxially cable assembly 200 of FIG. 9 is compared to the substantially coaxial cable assembly 100 of FIG. 4 wherein the coaxial cable alignment enhancer 220 does not contain or comprise the coaxial cable alignment enhancer 220, the plurality of electrical cables 228, which effectively form the radially outer annular or circumferential array of cables and which are seated within their respective axially oriented channels, pockets, or recesses 226 of the coaxial cable alignment enhancer 220, are now disposed in a truly coaxial manner with respect to each other and with respect to the central one 224 of the plurality of cables 202, and similarly for the contact members 204 disposed upon the free distal end portions of the plurality of electrical cables 228 which effectively form the radially outer annular or circumferential array of cables and which are seated within their respective axially oriented pockets, channels, or recesses 226 of the coaxial cable alignment enhancer 220.

Accordingly, when the electrical connector 206 is adapted to be physically and electrically connected to a corresponding complementary electrical connector, not shown, then as a result of, or in view of, the fact that the plurality of electrical cables 228, which effectively form the radially outer annular or circumferential array of cables and which are seated within their respective axially oriented channels, pockets, or recesses 226 of the coaxial cable alignment enhancer 220, are now disposed in a truly coaxial manner or array with respect to each other and with respect to the central one 224 of the plurality of electrical cables 202 disposed along the longitudinal axis LA of the coaxial cable assembly 200, all of the electrical contact members 204, respectively disposed upon the free distal end portions of all of the multiplicity of coaxially oriented and coaxially aligned cables 202, will be capable of being readily, easily, and properly engaged and mated with corresponding electrical contact members of the other corresponding or complementary electrical connector, not shown, with which the electrical connector 206 of the new and improved coaxial cable assembly 200 is to be physically and electrically connected, without incurring any damage, bending, or deformation.

Thus, it may be seen that in accordance with the principles and teachings of the present invention, there has been disclosed a new and improved coaxial cable assembly which comprises a coaxial cable alignment enhancer which is adapted to be disposed within the new and improved coaxial cable assembly at an axial position immediately upstream or behind the electrical connector as viewed in the axial direction of movement of the electrical connector when the electrical connector is to be physically and electrically connected to a corresponding or complementary electrical connector. The alignment enhancer comprises an axially elongated rod or tubular member having a plurality of axially oriented recesses, slots, or channels, disposed within an annular array, defined within the outer peripheral surface portion of the enhancer, and the multiplicity of coaxially oriented cables are adapted to be respectively disposed within the plurality of axially oriented recesses, slots, or channels. A securing member, which may comprise, for example, a tie, a band, a cable, a lace, a cord, tape, or the like, is disposed around the alignment enhancer so as to in fact maintain the multiplicity of coaxially oriented cables disposed within their respective axially oriented recesses, slots, or channels. In this manner, it is ensured that the multiplicity of coaxially oriented cables are in fact disposed in a true coaxial manner with respect to each other, and accordingly, the electrical contact members, respectively disposed upon the free distal end portions of the multiplicity of coaxially oriented and coaxially aligned cables, are themselves disposed in a true coaxial manner with respect to each other so as to be capable of being readily engaged and mated with corresponding electrical contact members of another electrical connector with which the electrical connector of the new and improved coaxial cable assembly is to be physically and electrically connected.

Lastly, it is noted that, in light of the foregoing disclosure, many variations and modifications of the present invention are possible. It is therefore to be understood that within the scope of the appended claims, the pre-sent invention may be practiced otherwise than as specifically described herein.

What is claimed as new and desired to be protected by Letters Patent of the United States of America, is:

1. A coaxial cable assembly, comprising:
an electrical connector defined around a longitudinal axis;
a backshell member also defined around said longitudinal axis;
means defined upon said electrical connector and said backshell member for separably connecting said backshell member and said electrical connector together;
a plurality of electrical cables, having electrical contact members respectively disposed upon forward down-stream end portions of said plurality of electrical cables, extending through said backshell member and said electrical connector in a substantially coaxial manner with respect to each other, and with respect to said longitudinal axis of said electrical connector and said backshell member, such that said electrical contact members, respectively disposed upon said forward downstream end portions of said plurality of electrical cables, extend through said electrical connector in order to be capable of being electrically mated to complementary contact members disposed within a complementary electrical connector when said electrical connector is connected to the complementary electrical connector;
an axially elongated alignment enhancer disposed internally within said backshell member and having a plurality of axially oriented recesses defined within outer peripheral surface portions thereof for respectively accommodating said plurality of electrical cables therewithin; and
a securing member disposed around said alignment enhancer for maintaining said plurality of electrical cables respectively seated within said plurality of axially oriented recesses defined within said outer peripheral surface portions of said alignment enhancer so as to ensure that said plurality of electrical cables, and said electrical contact members disposed upon said forward downstream end portions of said plurality of electrical cables, are in fact disposed in a truly coaxial manner with respect to each other, and with respect to said longitudinal axis of said electrical connector and said backshell member, in order to, in turn, facilitate the electrical connection of said plurality contact members of said plurality of electrical cables to the complementary contact members of the complementary electrical connector without said plurality of contact members undergoing deformation and damage.

2. The coaxial cable assembly as set forth in claim 1, wherein:
said plurality of axially oriented recesses, defined within said outer peripheral surface portions of said alignment enhancer for respectively accommodating said plurality of electrical cables therewithin, comprises seven axially oriented recesses.

3. The coaxial cable assembly as set forth in claim 2, wherein:
said seven axially oriented recesses, defined within said outer peripheral surface portions of said alignment enhancer, are disposed within a uniformly spaced circumferential array within said outer peripheral surface portions of said alignment enhancer.

4. The coaxial cable assembly as set forth in claim 2, wherein:
said alignment enhancer also has an axially located throughbore extending therethrough for accommodating an additional one of said plurality of electrical cables therewithin.

5. The coaxial cable assembly as set forth in claim 2, wherein:
said plurality of electrical cables, disposed upon and extending through said alignment enhancer, comprises seven electrical cables.

6. The coaxial cable assembly as set forth in claim 4, wherein:
said plurality of electrical cables, disposed upon and extending through said alignment enhancer, comprises eight electrical cables.

7. The coaxial cable assembly as set forth in claim 1, wherein:
said securing member is selected from the group comprising a cable, a tie, a lace, a cord, a band, and tape.

8. The coaxial cable assembly as set forth in claim 1, wherein:
said securing member is disposed within a radially extending plane located at a substantially axially central position of said alignment enhancer as considered along the axial extent of said alignment enhancer.

9. The coaxial cable assembly as set forth in claim 1, wherein:
said alignment enhancer is fabricated from a dielectric material.

10. A coaxial cable assembly, for use in conjunction with an electrical connector, defined around a longitudinal axis, and a backshell member also defined around said longitudinal axis, wherein said electrical connector and said backshell member are separably connected together, comprising:
a plurality of electrical cables, having electrical contact members respectively disposed upon forward down-stream end portions of said plurality of electrical cables, adapted to extend through said backshell member and said electrical connector in a substantially coaxial manner with respect to each other, and with respect to said longitudinal axis of said electrical connector and said backshell member, such that said electrical contact members, respectively disposed upon said forward downstream end portions of said plurality of electrical cables, extend through said electrical connector in order to be capable of being electrically mated to complementary contact members disposed within a complementary electrical connector when said electrical connector is connected to the complementary electrical connector;
an axially elongated alignment enhancer adapted to be disposed internally within said backshell member and having a plurality of axially oriented recesses defined within outer peripheral surface portions thereof for respectively accommodating said plurality of electrical cables therewithin; and
a securing member disposed around said alignment enhancer for maintaining said plurality of electrical cables respectively seated within said plurality of axially oriented recesses defined within said outer peripheral surface portions of said alignment enhancer so as to ensure that said plurality of electrical cables, and said electrical contact members disposed upon said forward downstream end portions of said plurality of electrical cables, are in fact disposed in a truly coaxial manner with respect to each other, and with respect to said longitudinal axis of said electrical connector and said backshell member, in order to, in turn, facilitate the electrical connection of said plurality contact members of said plurality of electrical cables to the complementary contact members of the complementary electrical connector without said plurality of contact members undergoing deformation and damage.

11. The coaxial cable assembly as set forth in claim 10, wherein:
said plurality of axially oriented recesses, defined within said outer peripheral surface portions of said alignment enhancer for respectively accommodating said plurality of electrical cables therewithin, comprises seven axially oriented recesses.

12. The coaxial cable assembly as set forth in claim 11, wherein:
said seven axially oriented recesses, defined within said outer peripheral surface portions of said alignment enhancer, are disposed within a uniformly spaced circumferential array within said outer peripheral surface portions of said alignment enhancer.

13. The coaxial cable assembly as set forth in claim 11, wherein:
said alignment enhancer also has an axially located throughbore extending therethrough for accommodating an additional one of said plurality of electrical cables therewithin.

14. The coaxial cable assembly as set forth in claim 11, wherein:
said plurality of electrical cables, disposed upon and extending through said alignment enhancer, comprises seven electrical cables.

15. The coaxial cable assembly as set forth in claim 13, wherein:
said plurality of electrical cables, disposed upon and extending through said alignment enhancer, comprises eight electrical cables.

16. The coaxial cable assembly as set forth in claim 10, wherein:
said securing member is selected from the group comprising a cable, a tie, a lace, a cord, a band, and tape.

17. The coaxial cable assembly as set forth in claim 10, wherein:
said securing member is disposed within a radially extending plane located at a substantially axially central position of said alignment enhancer as considered along the axial extent of said alignment enhancer.

18. The coaxial cable assembly as set forth in claim 10, wherein:
said alignment enhancer is fabricated from a dielectric material.
